(19) United States
(12) Patent Application Publication
(10) Pub. No.: US 2013/0031116 A1
(43) Pub. Date: Jan. 31, 2013

(54) MODELED BUSINESS OBJECT DATA IMPORT

(71) Applicant: Oliver Klemenz, Heidelberg (DE)

(72) Inventor: Oliver Klemenz, Heidelberg (DE)

(21) Appl. No.: 13/194,102

(22) Filed: Jul. 29, 2011

(51) Int. Cl. G06F 17/30

(52) U.S. Cl. 707/756; 707/802; 707/E17.005

(57) ABSTRACT

A computer-implemented system may include reception of a selection of a business object, reception of a selection of one or more nodes of the business object, creation of a schema definition based on the selected one or more nodes, reception of an eXtended Markup Language file conforming to the schema definition, the eXtended Markup Language file including instance values associated with the one or more nodes of the business object, and population of an instance of the business object with the values associated with the one or more nodes of the business object.

### FIELD

Some embodiments relate to an application platform providing functionality based on business objects. More specifically, some embodiments relate to systems to populate business object instances with imported data.

### BACKGROUND

An application platform may implement metadata models to support different business solutions. Metadata models may include generic models of a business object, a floorplan (i.e., a user interface layout), user interface text, a process component, and a message type, among others. A business object, for example, is a software model representing real-world items used during the transaction of business. An instance of a business object metadata model may comprise a SalesOrder object model or an Organization object model. Instances of these object models, in turn, represent specific data (e.g., SalesOrder 4711, ACME corporation).

An instance of a business object metadata model (e.g., a SalesOrder object model or, more generically, a business object) may specify business logic and/or data having any suitable structure. The structure may be determined based on the requirements of a business scenario in which the instance is to be deployed. A business application for a particular business scenario may require many business objects, where the structure of each has been determined based on the requirements of the particular business scenario.

The application platform may allow developers to create new business objects, as well as processes which utilize instances of these business objects. For example, a developer may wish to allow a user to input data into instances of a new business object. If so, the developer must manually create metadata entities to define this input, and must manually implement corresponding process agent logic in code. Moreover, an appropriate runtime configuration for handling the input must be manually established.

These manual tasks must comply with development guidelines of the application platform, and therefore require expensive developer training efforts and typically lead to long implementation times. Development errors are nevertheless likely to occur.

### BRIEF DESCRIPTION OF THE DRAWINGS

FIG. 1 is a block diagram of a system according to some embodiments.

FIG. 2 is a flow diagram of process steps according to some embodiments.

FIG. 3 is a representation of business object metadata according to some embodiments.

FIGS. 4-17 comprise outward views of user interfaces according to some embodiments.

FIG. 18 is a block diagram of a computing system according to some embodiments.

### DETAILED DESCRIPTION

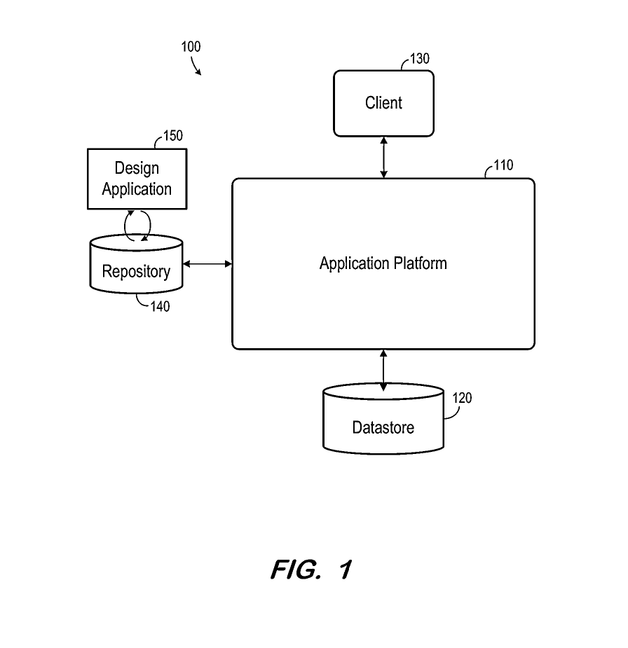

FIG. 1 is a block diagram of system 100 according to some embodiments. System 100 includes application platform 110, datastore 120, client 130, metadata repository 140 and design application 150. Each of the illustrated components may be implemented by software and/or one or more hardware elements, with some software and/or hardware elements being shared among more than one illustrated component.

Application platform 110 may implement a service-oriented architecture, thereby providing services (i.e., business functionality) to service consumers. Such service consumers use this business functionality to provide user interfaces, application-to-application or business-to-business integration, output management (e.g., printing), spreadsheet download, etc. According to the illustrated embodiment, the business functionality may include retrieving, creating, modifying and/or deleting the data of business object instances stored in datastore 120. Datastore 120 may comprise any one or more systems to store business data. Such systems include, but are not limited to, relational database systems, Online Analytical Processing (OLAP) database systems, data warehouses, application servers, and flat files.

Repository 140 stores metadata defining business objects and other logical structures used by application platform 110. A developer may modify and/or create metadata within repository 140 using design application 150. Application platform 110 may create and store runtime entities based on the metadata of repository 140.

Briefly, according to some embodiments, system 100 operates to receive a selection of one or more nodes of a business object from design application 150, create a schema definition based on the selected one or more nodes, create runtime objects to map a file conforming to the schema definition to the selected one or more nodes, receive an eXtended Markup Language file from client 130 conforming to the schema definition and including instance values associated with the one or more nodes of the business object, and use the runtime objects to populate an instance of the business object with the values associated with the one or more nodes of the business object. Some embodiments of the foregoing will be described in detail below.

FIG. 1 represents a logical architecture for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 100 may include a processor to execute program code such that the computing device operates as described herein.

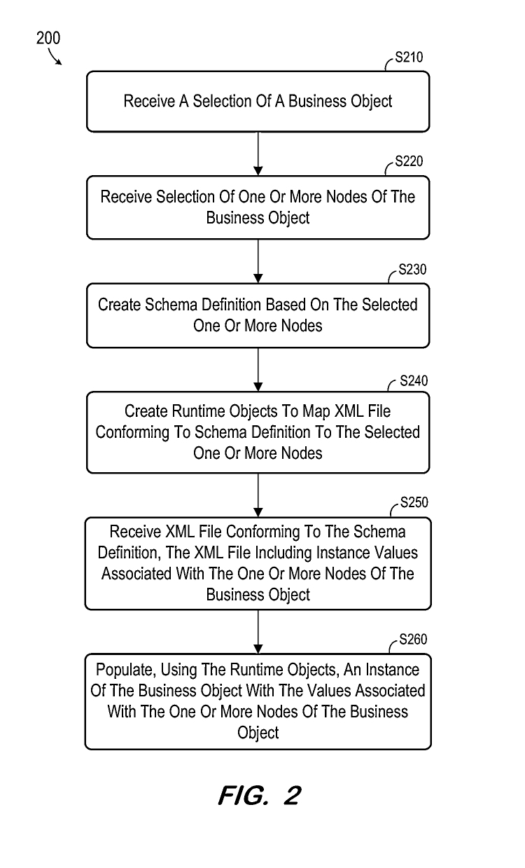

FIG. 2 comprises flow diagram of process 200 according to some embodiments. In some embodiments, various hardware elements of an application platform execute program code to perform process 200.

All processes mentioned herein may be embodied in computer-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

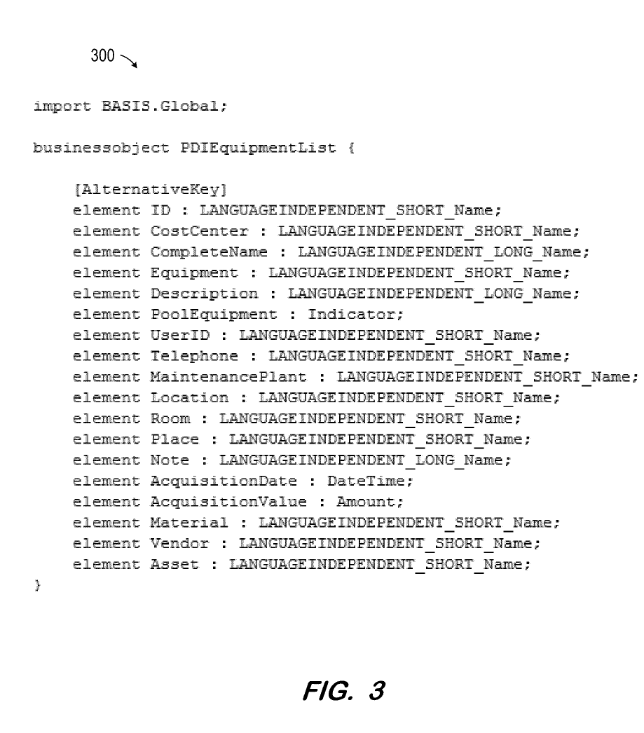

Initially, at S210, a selection of a business object is received. The selected business object may be defined by metadata of repository 140, and may comprise a standard business object (e.g., SalesOrder) provided by the provider of application platform 110, or a business object created by a developer using design application 150 and represented within metadata of repository 140. For example, FIG. 3 is a representation of metadata 300 defining the business object PDIEquipmentList, which will be considered in the present example.

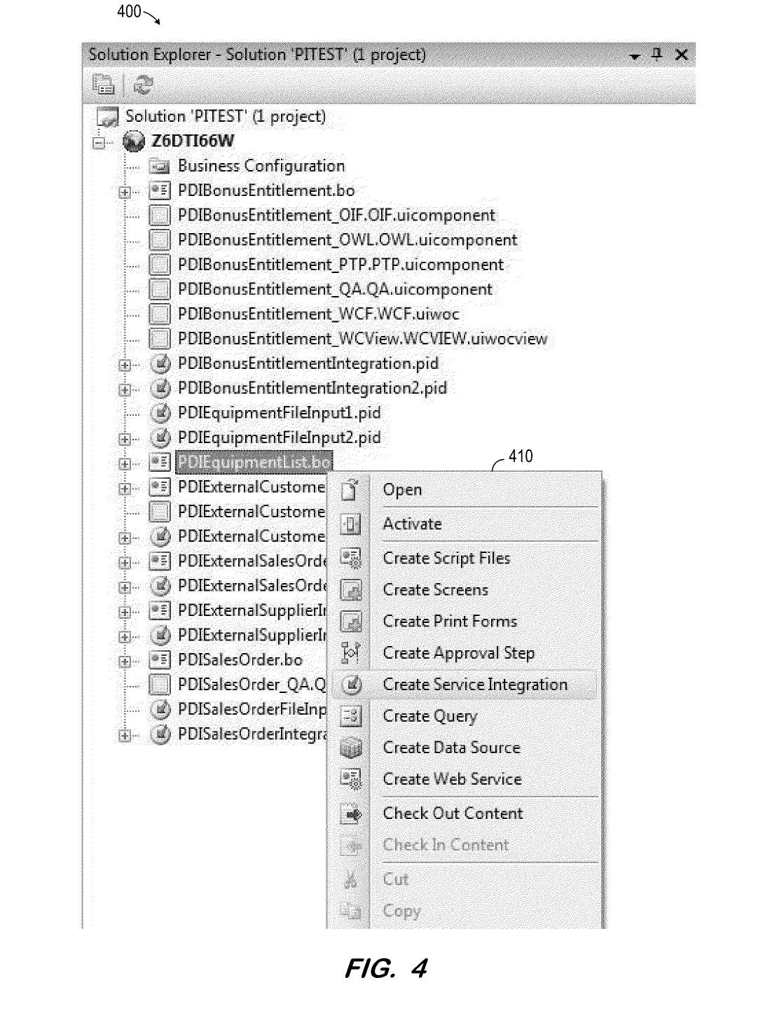

FIG. 4 illustrates interface 400 which may be used by a developer to select a business object at S210 according to some embodiments. Interface 400 may comprise a window presented by a computing device executing program code of designer application 150. Interface 400 lists the business object PDIEquipmentList as “PDIEquipmentList.bo”. In this regard, the business object PDIEquipmentList is currently active (i.e., usable) within system 100.

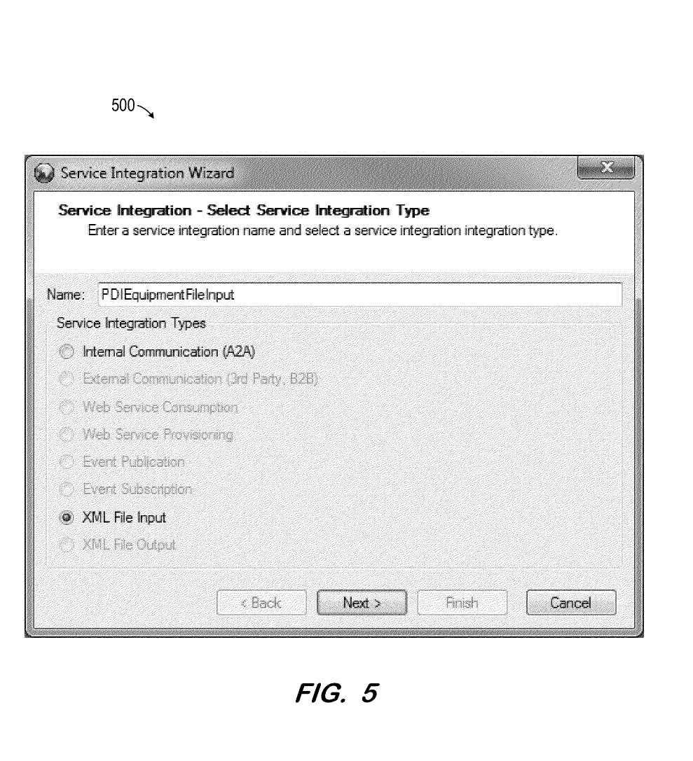

The text PDIEquipmentList.bo has been “right-clicked”, resulting in display of context menu 410. The developer, according to the present example, then selects “Create Service Integration” from context menu 410. According to some embodiments, this selection causes designer application 150 to launch a service integration wizard, the interfaces of which are shown in FIGS. 5 through 8 and described below.

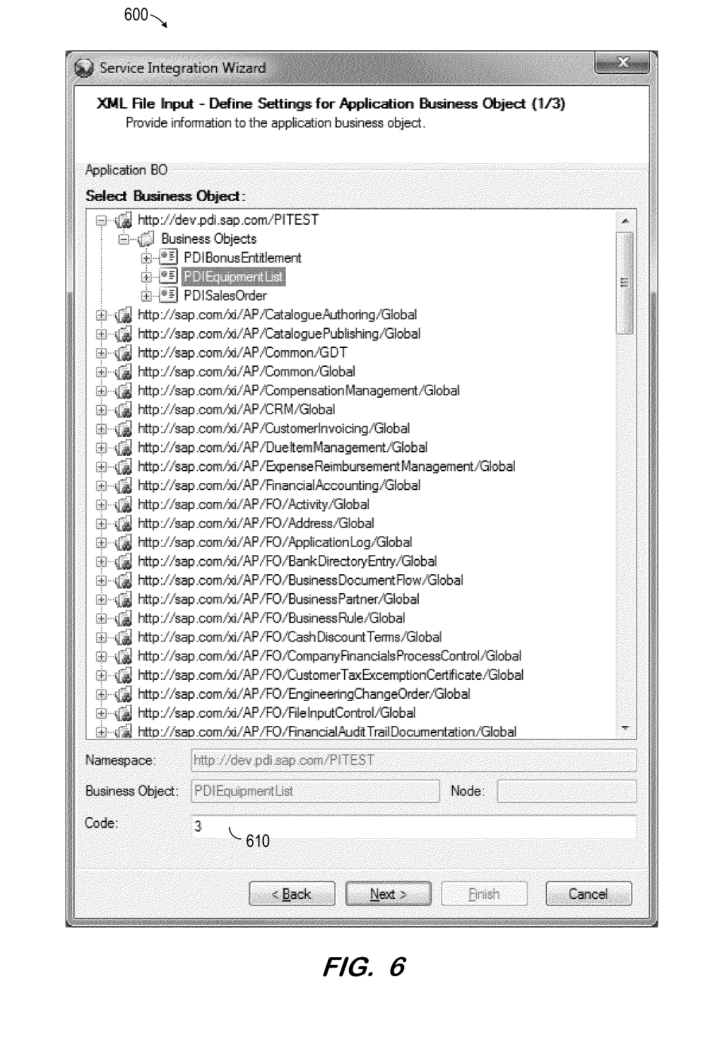

Initially, the developer enters “PDIEquipmentFileInput” into interface 500 to name the present service integration (or, more specifically, input model) and indicate that the service integration represents an XML file input. Interface 600 of FIG. 6 is presented upon selection of the Next button of interface 500.

Interface 600 presents all active and publicly-visible business objects of system 100, with the previously-selected business object PDIEquipmentList as selected by default. The developer may alternatively select any other business object of interface 600 according to some embodiments. The developer assigns a code to the service integration using field 610 and selects the Next button.

Returning to process 200, a selection of one or more nodes of the selected business object is received at S220. Interface 700, which is presented in response to the selection of the Next button of interface 600, provides checkboxes for receiving selections of various nodes of the selected business object at S220. In the present example, the root node is selected, thereby causing selection of each other node of the business object. According to some examples, the developer selects less than all the nodes of the business object at S220.

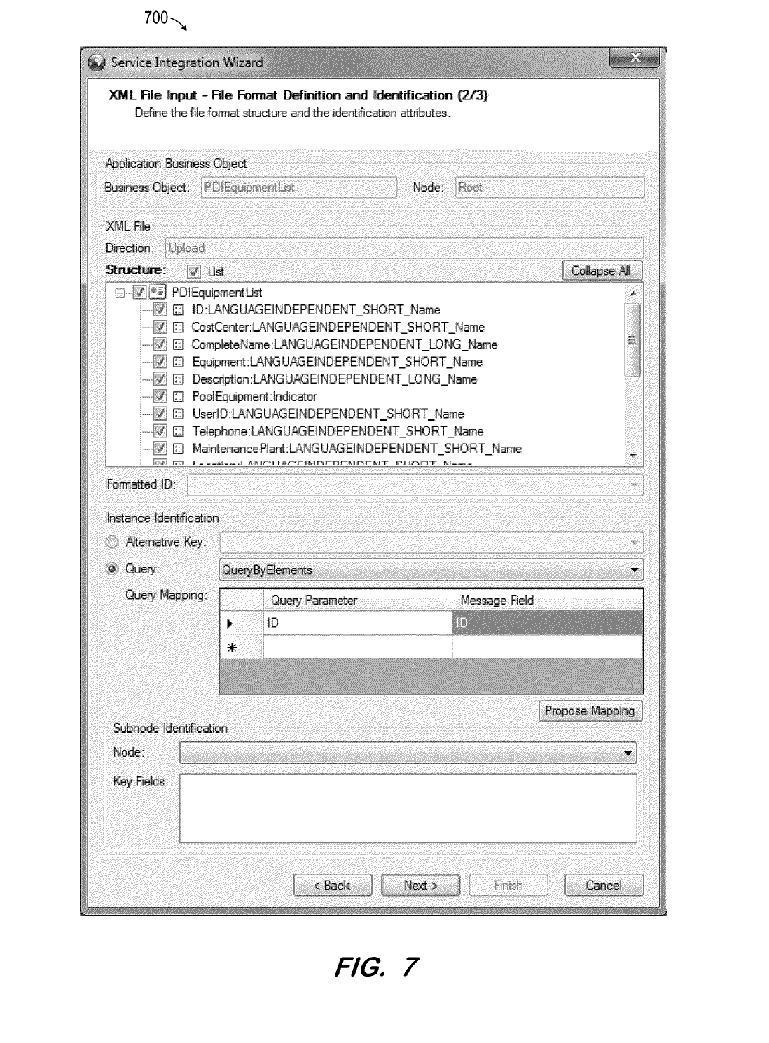

As will be understood, the selected nodes will dictate the structure of eXtended Markup Language files used to populate instances of the selected business object. According to the embodiment shown in FIG. 7, the instances will be identified using a QueryByElements query on parameter ID. As shown, instances may be identified using an alternative key, and more than one sub-nodes and key fields thereof may also be identified.

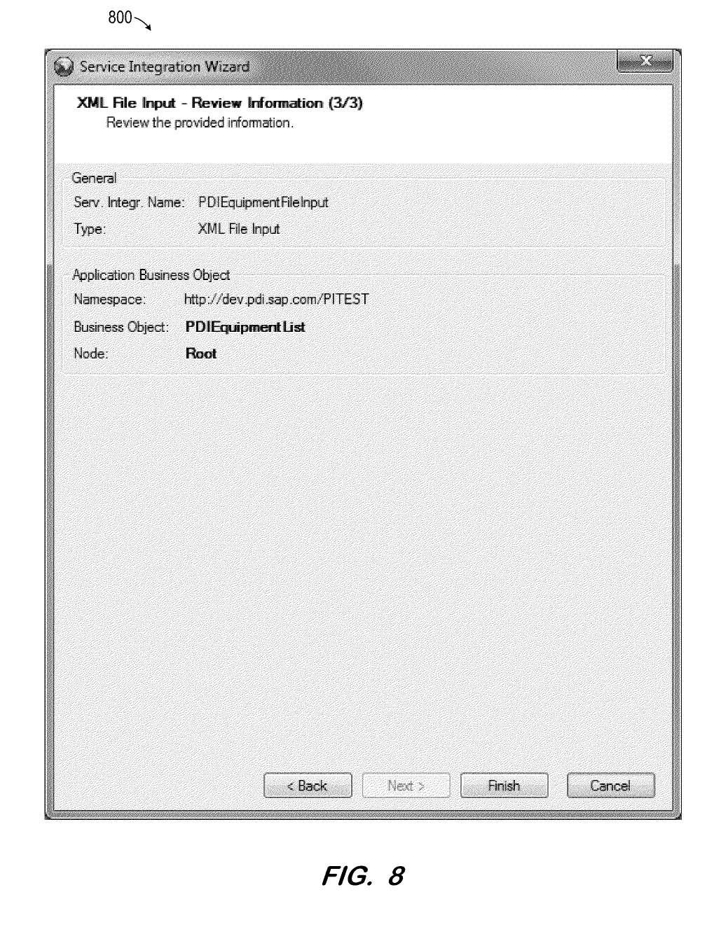

The user may then select the Next button of interface 700. FIG. 8 illustrates interface 800 for reviewing the information received via interfaces 500-700. Interface 800 provides a Back button for modifying the information, and a Finish button for saving the information and exiting the wizard.

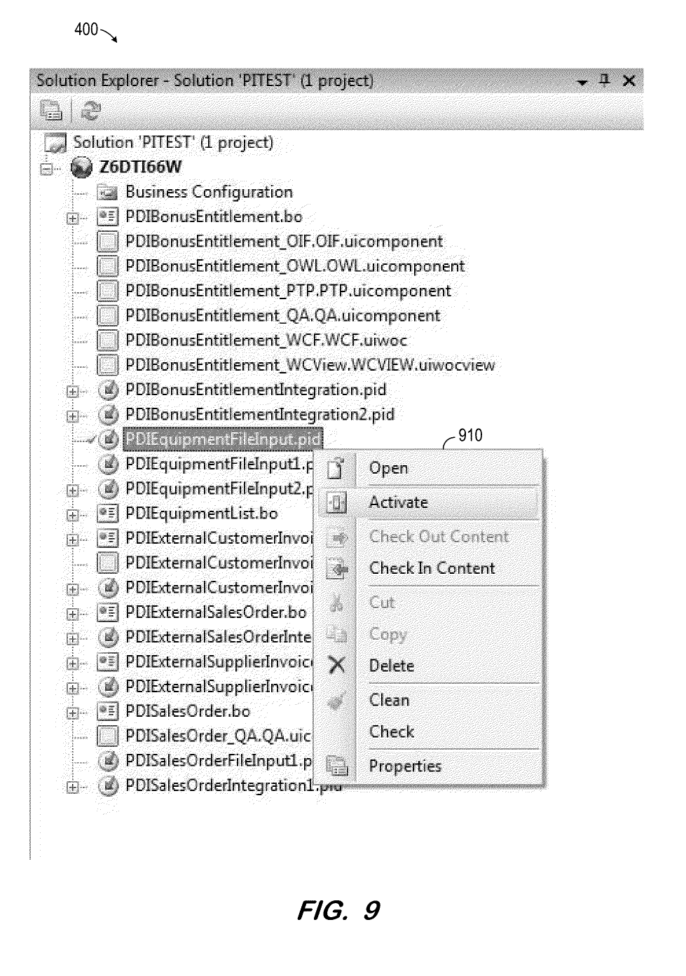

Continuing with the present example, as shown in FIG. 9, interface 400 now lists the newly-created service integration PDIEquipmentFileInput.pid. “PDIEquipmentFileInput.pid” is right-clicked and “Activate” is selected from subsequently-displayed context menu 910 to create a corresponding schema definition at S230. The schema definition is created based on the selected one or more nodes. As mentioned above, the schema definition defines the structure of eXtended Markup Language files used to populate instances of the corresponding business object (i.e., PDIEquipmentList). In this regard, the schema definition itself may comprise an eXtended Markup Language file as will be demonstrated below.

Selection of Activate from menu 910 also results in the creation of runtime objects corresponding to the schema definition at S240. The runtime objects are used to map an input XML file (i.e., conforming to the schema definition) to the selected one or more nodes such that instances of the nodes may be populated with values within the XML file. The runtime objects may be stored in datastore 120.

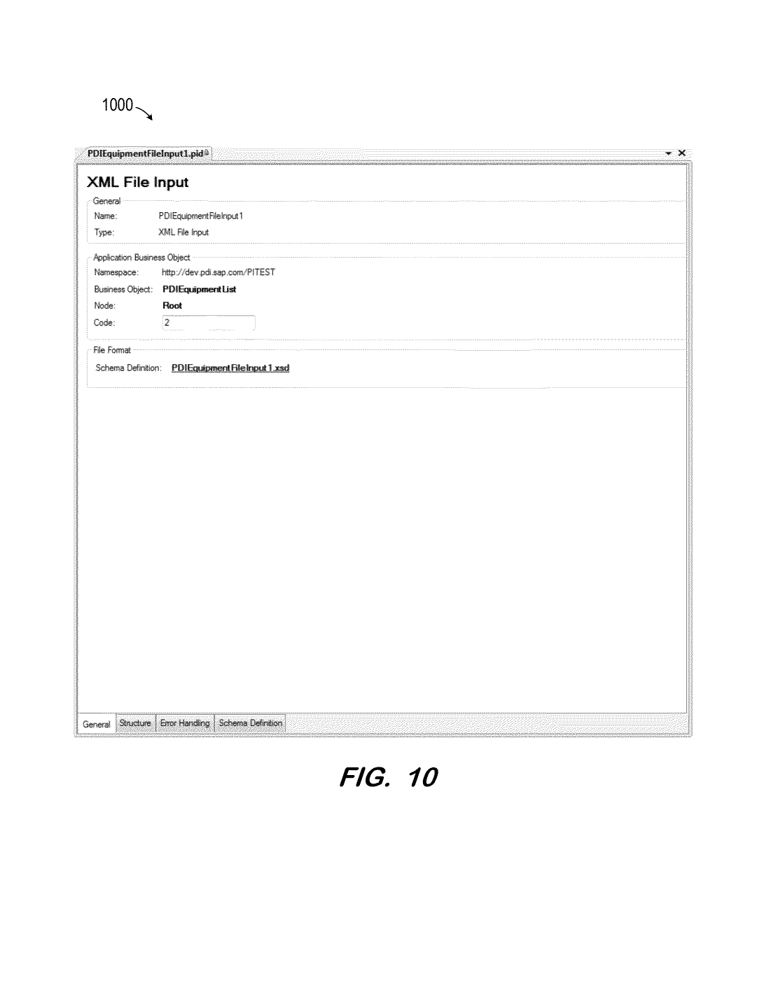

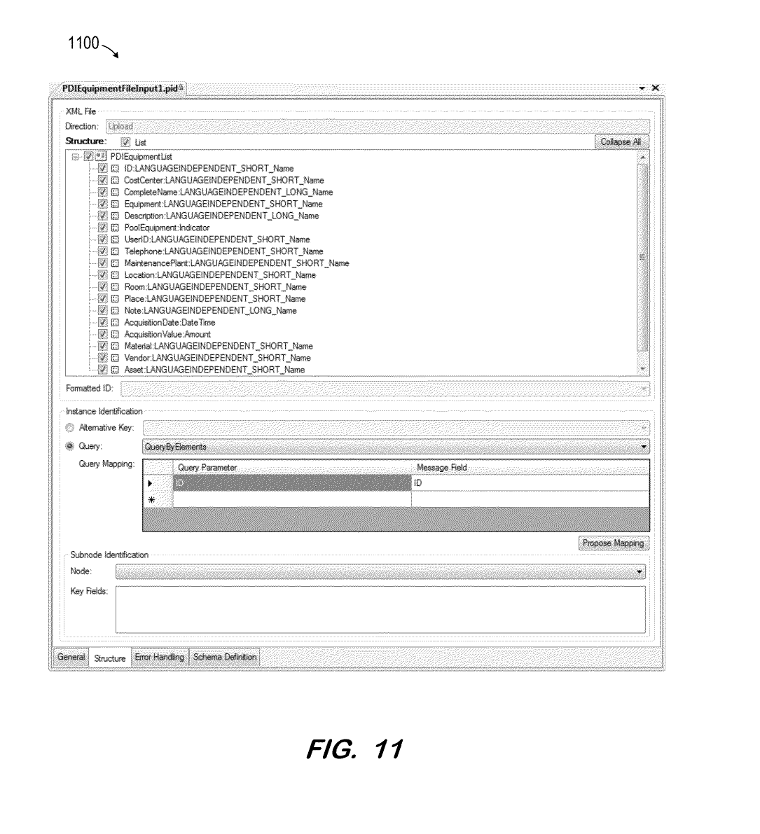

Designer application 150 may further provide interfaces 1000 through 1300 to review and redefine the created schema definition. Interface 1000 of FIG. 10 is similar to above-described interface 800 but also includes link PDIEquipmentFileInput1.xsd for downloading the schema definition. Interface 1100 of FIG. 11 is similar to interface 700 and allows review and revision of the selected nodes and the instance identification information.

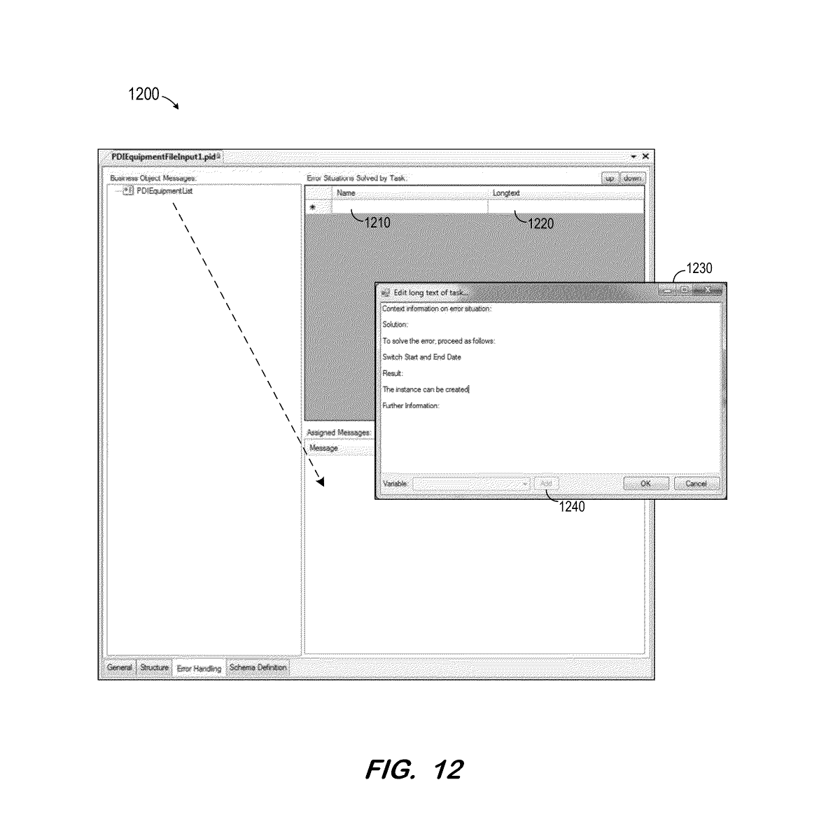

FIG. 12 illustrates interface 1200 to define error handling. According to the present example, the developer may enter a name for the error situation in name field 1210, and may drag any message associated with the selected business object into the Assigned Messages window of interface 1200. Selection of Longtext field 1220 results in display of interface 1230, into which the developer may enter text to describe the error situation. Interface 1230 also includes Add button 1240 for adding variables of the assigned business object message to the description, if available.

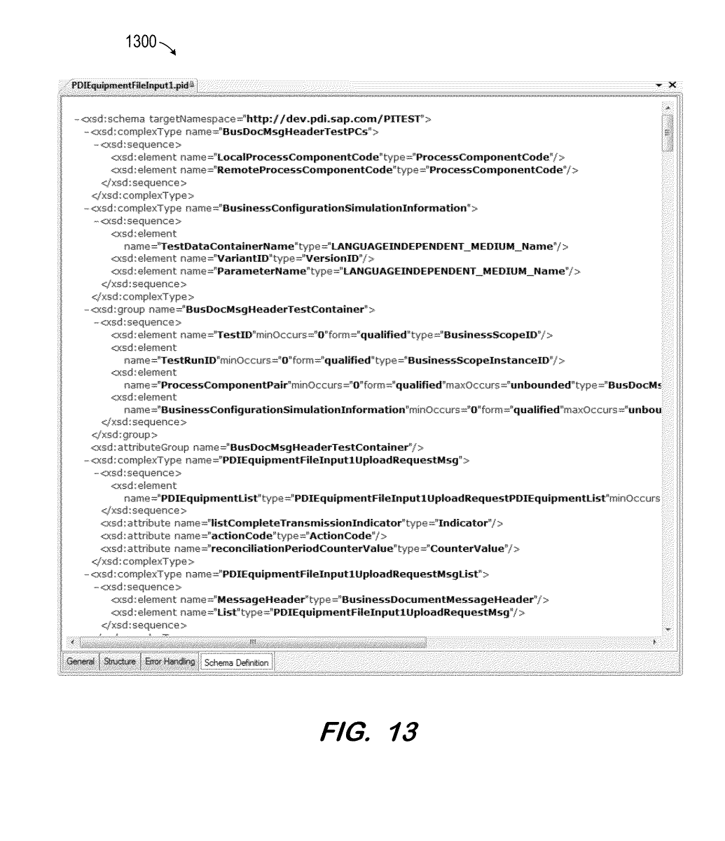

The schema definition itself, in XML format, is viewable via interface 1300 of FIG. 13. Again, the schema definition defines the structure of eXtended Markup Language files used to populate instances of the corresponding business object.

The above-described steps provide a modeled service integration that may be executed by a generic framework. Accordingly, a developer may provide population of business object instances without time-consuming and error-prone manual creation of corresponding metadata entities, process agent logic and runtime configurations. Creation and use of an XML file to populate business object instances according to some embodiments will now be described.

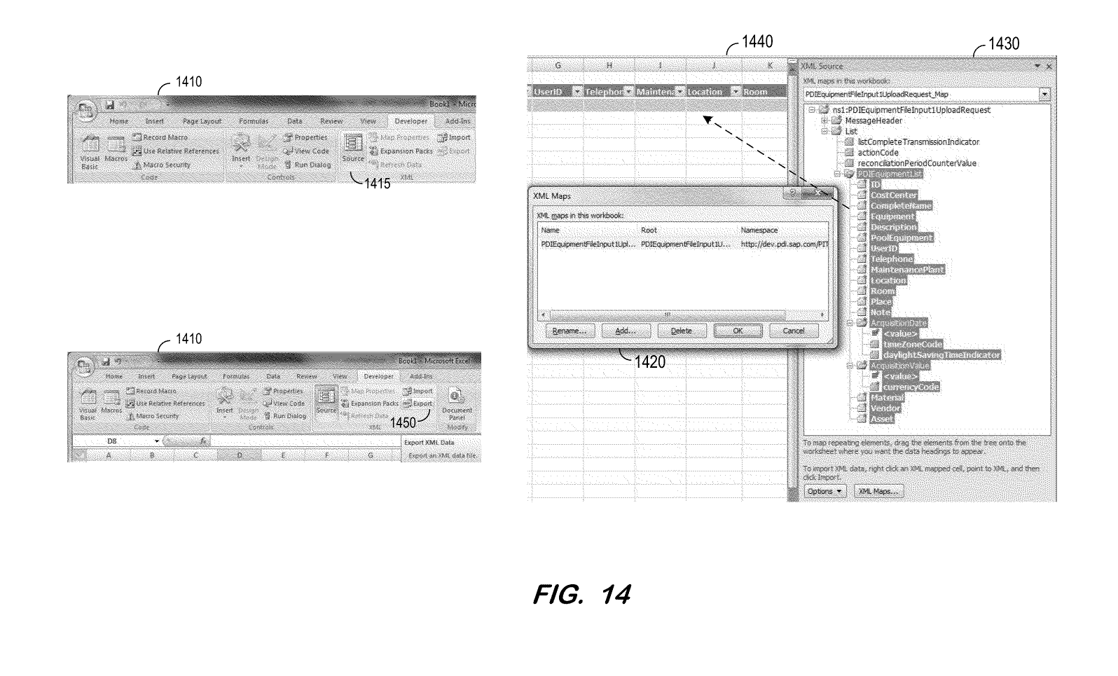

FIG. 14 illustrates various interface portions for describing creation of an XML file prior to S250 according to some embodiments. The XML file is to conform to the schema definition created at S230. Such a file could be created manually using the schema as a guide, but such creation would be time consuming, particularly as the number of instances to be populated increases.

The images of FIG. 14 are presented by a desktop spreadsheet application executing on client 130. The upper image of toolbar portion 1410 illustrates selection of Source button 1415. This selection causes display of XML Maps interface 1420, from which the developer may select the schema definition of the present example. Source window 1430 is then displayed with existing spreadsheet 1440, and the schema elements of window 1430 may be dragged-and-dropped onto fields of spreadsheet 1440 to bind the elements to respective fields. Next, export button 1450 of toolbar 1410 is selected to create an XML file conforming to the schema definition and including values of the spreadsheet fields mapped to repective nodes of the business object.

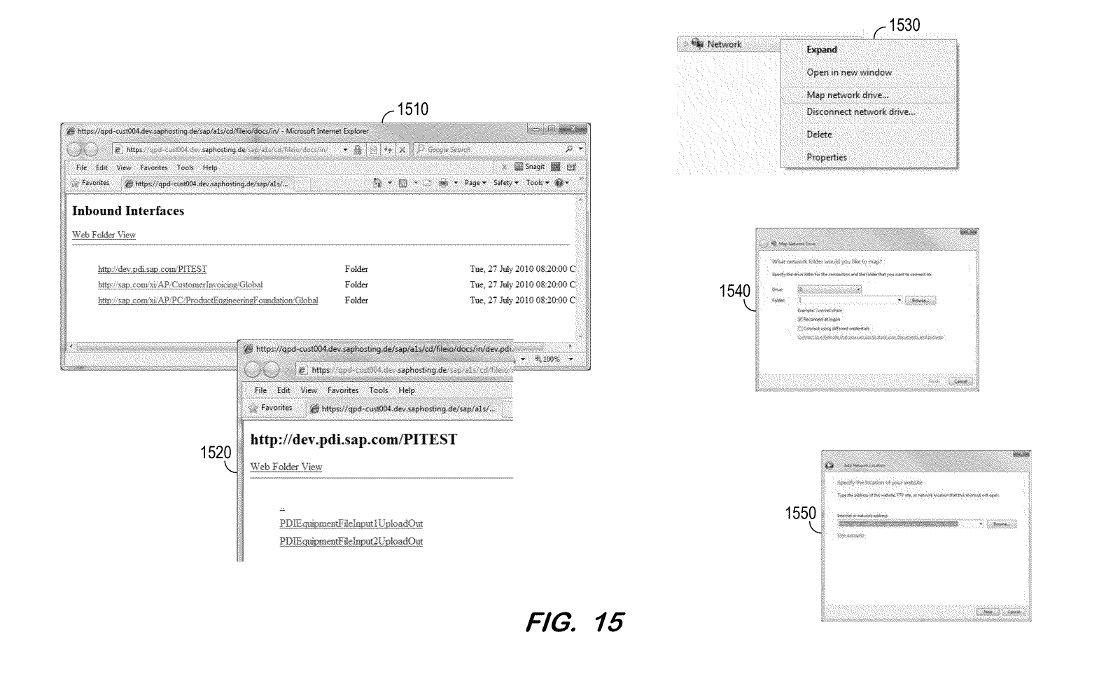

FIG. 15 illustrates one method to transmit the XML file to system 100 at S250. In this regard, system 100 provides Web folders in which client 130 may store files. The Web folder URL (e.g., https://qpd-cust004.dev.saphosting.de/sap/a1s/cd/fileio/docs/ni) is input into a Web browser executing on client 130, causing presentation of corresponding page 1510. Drill-down page 1520, showing child Web folders, is presented upon selection of a link within page 1510. Each child Web folder is associated with a service integration, therefore any XML files stored in a Web folder may be processed based on the runtime objects created for the service integration associated with the Web folder.

Images 1530 through 1550 illustrate mapping of a network drive of client 130 to one of the Web folders. Once this mapping is complete, the user may transmit the locally-stored XML file to one of the Web folders of application platform 110 by simply copying the XML file to the corresponding network drive.

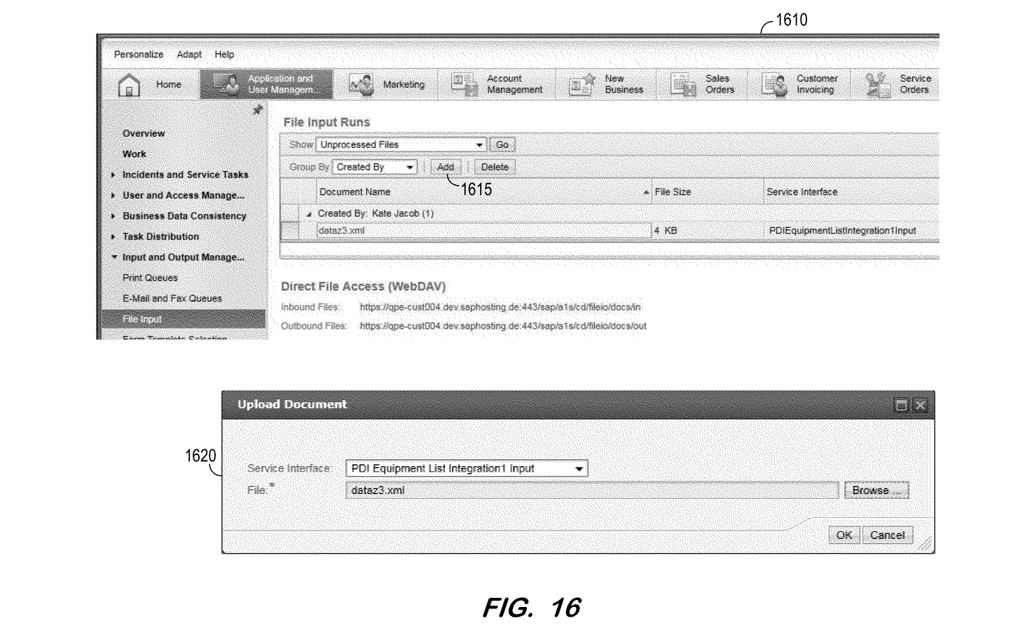

FIG. 16 illustrates another method to transmit an XML file corresponding to the schema definition to system 100. Interface 1610 may be an interface of an on-demand Web service-based application provided by application platform 100 and presented on client 130. Upon selection of Add button 1615, a user is presented with Upload dialog 1620. Upload dialog 1620 allows selection of a service interface (i.e., corresponding to the schema definition and business object of interest) and an XML file which conforms to the schema and includes values to populate instances of the business object according to the schema definition.

Upon receiving an XML file including instance values and an identification of the service integration/schema definition with which the XML file is associated, application platform 110 may use the runtime objects created based on the schema definition to populate one or more instances of the corresponding business object with the values at S260. It may be preferable to schedule this instance population to occur at specific times such that all not-yet-processed XML files can be processed en masse.

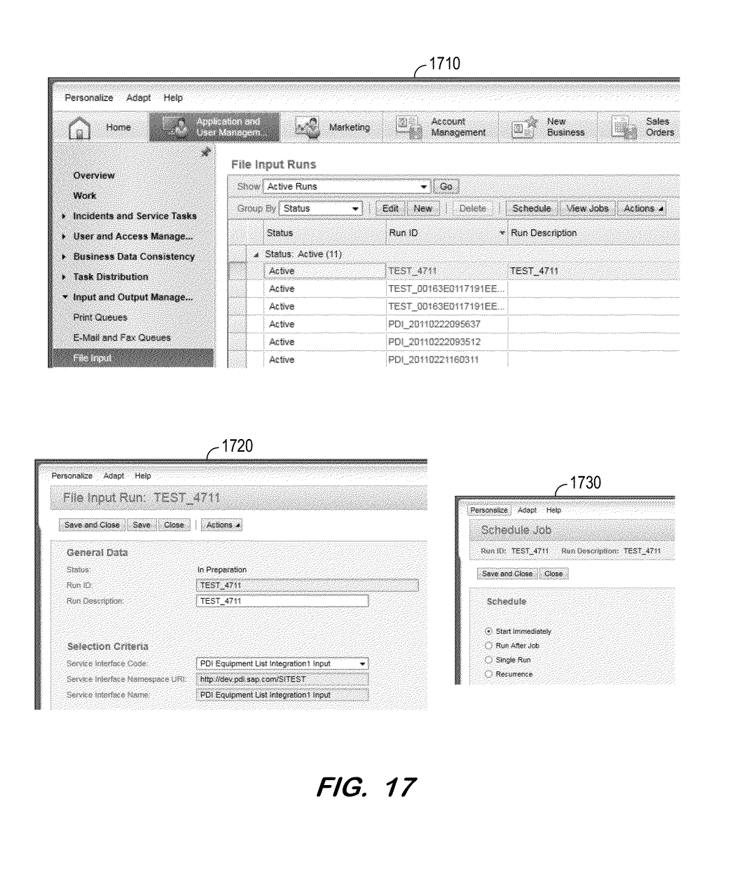

FIG. 17 illustrates the scheduling of file input at S260 for a particular service integration according to some embodiments. Interface 1710 may also comprise an interface of an on-demand Web service-based application provided by application platform 100 and presented on client 130. Interface 1720, accessible via Edit button 1712 or New button 1714, allows a user to identify a file input run and indicate a service interface (i.e., integration) with which the run is associated. Interface 1730 is accessible through Schedule button 1716 and allows scheduling of the file input run. Therefore, according to the defined schedule, all XML files associated with the service interface, which have been received by application platform 110, and which have not yet been processed will be processed to populate corresponding business object instances.

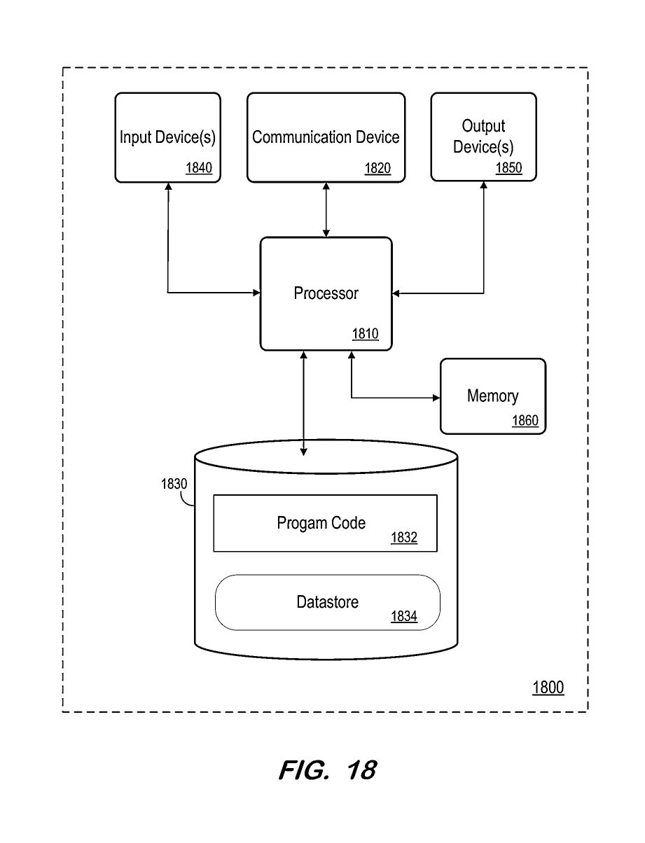

FIG. 18 is a block diagram of apparatus 1800 according to some embodiments. Apparatus 1800 may comprise a general-purpose computing apparatus and may execute program code to perform any of the functions described herein. Apparatus 1800 may comprise an implementation of system 100. Apparatus 1800 may include other unshown elements according to some embodiments.

Apparatus 1800 includes processor 1810 operatively coupled to communication device 1820, data storage device 1830, one or more input devices 1840, one or more output devices 1850 and memory 1860. Communication device 1820 may facilitate communication with external devices, such as a reporting client, or a data storage device. Input device(s) 1840 may comprise, for example, a keyboard, a keypad, a mouse or other pointing device, a microphone, knob or a switch, an infra-red (IR) port, a docking station, and/or a touch screen. Input device(s) 1840 may be used, for example, to enter information into apparatus 1800. Output device(s) 1850 may comprise, for example, a display (e.g., a display screen) a speaker, and/or a printer.

Data storage device 1830 may comprise any appropriate persistent storage device, including combinations of magnetic storage devices (e.g., magnetic tape, hard disk drives and flash memory), optical storage devices, Read Only Memory (ROM) devices, etc., while memory 1860 may comprise Random Access Memory (RAM).

Program code 1832 may be executed by processor 1810 to cause apparatus 1800 to perform any one or more of the processes described herein. Embodiments are not limited to execution of these processes by a single apparatus. Datastore 1834 may store object instance data, runtime objects, schema definitions, XML files conforming to the schema definitions and including instance values, and/or any other data described herein. Data storage device 1830 may also store data and other program code for providing additional functionality and/or which are necessary for operation thereof, such as device drivers, operating system files, etc.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

The embodiments described herein are solely for the purpose of illustration. Those in the art will recognize other embodiments may be practiced with modifications and alterations limited only by the claims.

1. A computer-implemented method comprising:
receiving a selection of a business object, the business object having a plurality of nodes;
receiving a selection of one or more nodes from among the plurality of nodes;
creating a schema definition based on the selected one or more nodes;
receiving an eXtended Markup Language file having a structure defined by the schema definition, the eXtended Markup Language file including instance values associated with the selected one or more nodes; and
populating an instance of the business object with the values associated with the selected one or more nodes.

2. The computer-implemented method according to claim 1,
wherein a quantity equal to an amount of the selected one or more nodes is less than a quantity equal to an amount of the plurality of nodes.

3. The computer-implemented method according to claim 1,
wherein the schema definition is a second eXtended Markup Language file.

4. The computer-implemented method according to claim 3, further comprising:
creating runtime objects to map a file conforming to the schema definition to the selected one or more nodes,
wherein populating the instance of the business object comprises using the runtime objects to populate the instance of the business object with the values associated with the one or more nodes of the business object.

5. The computer-implemented method according to claim 1, further comprising:
creating runtime objects to map a file conforming to the schema definition to the selected one or more nodes,
wherein populating the instance of the business object comprises using the runtime objects to populate the instance of the business object with the values associated with the one or more nodes of the business object.

6. A non-transitory computer-readable medium storing program code executable by a computing system, the program code comprising:
code to receive a selection of a business object, the business object having a plurality of nodes;
code to receive a selection of one or more nodes from among the plurality of nodes;
code to create a schema definition based on the selected one or more nodes;
code to receive an eXtended Markup Language file having a structure defined by the schema definition, the eXtended Markup Language file including instance values associated with the selected one or more nodes; and
code to populate an instance of the business object with the values associated with the selected one or more nodes.

7. The medium according to claim 6,
wherein a quantity equal to an amount of the selected one or more nodes is less than a quantity equal to an amount of the plurality of nodes.

8. The medium according to claim 6, wherein the schema definition is a second eXtended Markup Language file.

9. The medium according to claim 8, the program code further comprising:
code to create runtime objects to map a file conforming to the schema definition to the selected one or more nodes,
wherein the code to populate the instance of the business object comprises code to use the runtime objects to populate the instance of the business object with the values associated with the one or more nodes of the business object.

10. The medium according to claim 6, the program code further comprising:
code to create runtime objects to map a file conforming to the schema definition to the selected one or more nodes,
wherein the code to populate the instance of the business object comprises code to use the runtime objects to populate the instance of the business object with the values associated with the one or more nodes of the business object.

11. A computing system comprising:
a memory storing processor-executable process steps; and
a processor to execute the processor-executable process steps to cause the system to:
receive a selection a business object, the business object having a plurality of nodes;
receive a selection of one or more nodes from among the plurality of nodes;
create a schema definition based on the selected one or more nodes;
receive an eXtended Markup Language file having a structure defined by the schema definition, the eXtended Markup Language file including instance values associated with the selected one or more nodes; and
populate an instance of the business object with the values associated with the selected one or more nodes.

12. The computing system according to claim 11,
wherein a quantity equal to an amount of the selected one or more nodes is less than a quantity equal to an amount of the plurality of nodes.

13. The computing system according to claim 11,
wherein the schema definition is a second eXtended Markup Language file.

14. The computing system according to claim 13, the processor further to execute the processor-executable process steps to:
create runtime objects to map a file conforming to the schema definition to the selected one or more nodes,
wherein population of the instance of the business object comprises usage of the runtime objects to populate the instance of the business object with the values associated with the one or more nodes of the business object.

15. The computing system according to claim 11, the processor further to execute the processor-executable process steps to:
create runtime objects to map a file conforming to the schema definition to the selected one or more nodes,
wherein population of the instance of the business object comprises usage of the runtime objects to populate the instance of the business object with the values associated with the one or more nodes of the business object.
